(19) United States
(12) Patent Application Publication
(10) Pub. No.: US 2025/0223225 A1
(43) Pub. Date: Jul. 10, 2025

(54) CONSTRUCTION MATERIAL DRY MIXES CONTAINING SOLID VINYL ESTER RESINS

(71) Applicant: Wacker Chemie AG, Munich (DE)

(72) Inventors: Markus Bannwarth, Munich (DE); Peter Fritze, Munich (DE)

(73) Assignee: Wacker Chemie AG, Munich (DE)

(21) Appl. No.: 18/682,133

(22) PCT Filed: Aug. 10, 2021
(86) PCT No.: PCT/EP2021/072212

§ 371 Date: Feb. 8, 2024

(51) Int. Cl. C04B 24/16; C04B 24/26; C04B 28/02; C04B 40/00; C08F 2/04; C08F 4/34; C08F 218/08

(52) U.S. Cl. CPC C04B 24/163; C04B 24/2688; C04B 28/02; C04B 40/0042; C08F 2/04; C08F 4/34; C08F 218/08

(57) ABSTRACT

A construction material dry mix contains one or more hydraulically setting binders, one or more fillers and optionally one or more additives. The construction material dry mix also contains one or more water-soluble solid vinyl ester resins, obtainable by solution polymerization or bulk polymerization of 60% to 99.4% by weight of one or more vinyl esters of carboxylic acids having 1 to 20 carbon atoms, 0.1% to 20% by weight of one or more ethylenically unsaturated monomers containing silane groups, and 0.5% to 20% by weight of one or more ionic, ethylenically unsaturated monomers, where the figures in % by weight are each based on the total weight of the solid vinyl ester resins.

The present invention relates to construction material dry mixes containing solid vinyl ester resins, and to solid vinyl ester resins and processes for preparing the solid vinyl ester resins, and to the use of the construction material dry mixes for example as bonding agents or coating materials, more particularly as tile adhesives, joint fillers, as adhesives for thermal insulation composite systems, or as coating materials in the form of self-leveling compounds.

On the increase for some time has been the use, in mineral construction material mixes, of protective colloid-stabilized polymers powders or polymer dispersions, for equipping chemical construction products, such as tile adhesives, joint fillers, screeds, sealing slurries or thermal insulation composite systems, with improved mechanical properties. Flexural strength, flexibility or adhesive strengths in particular have been improved in this way. Polymers stabilized by protective colloid are customarily produced by emulsion or suspension polymerization in aqueous medium and converted by subsequent drying, especially spray drying, into redispersible polymer powders.

To further improve the adhesive tensile strengths of construction products, protective colloid-stabilized polymers with specific monomer compositions have been recommended, including, for example, terpolymers based on well-balanced amounts of vinyl acetate, vinyl chloride and ethylene, as described in WO-A 2013/178721, EP0334591 and EP-A 0255363. EP-A 1262465 teaches, for these purposes, a multistage emulsion or suspension polymerization of vinyl esters and (meth)acrylic esters. Polymer mixtures of vinyl ester copolymers with different glass transition temperatures have also been recommended for improving the water resistance and/or heat resistance of application products, in EP-B1 2158265, WO-A 2006/099960 or EP-A 702057, for example. EP-A 2399955 teaches polymer mixtures of styrene-butadiene copolymers with different glass transition temperatures. Additives as well have been used to control the performance properties of construction products. For instance, EP-A 1238958 recommends zinc oxides, zinc hydroxide or zinc hydroxide carbonate for retarding the setting of cementitious mortar compounds, without impairing the water resistance of the construction products.

Outside of the construction sector as well, suspension or emulsion polymers stabilized with protective colloid or emulsifier are diversely employed. For instance, WO-A1 2018/148929 describes aqueous dispersions of water-insoluble polymers based on ethylenically unsaturated silanes, polymerizable anionic emulsifiers, further ethylenically unsaturated monomers, and optionally ethylenically unsaturated epoxy compounds as adhesive for bonding porous polymer materials. U.S.-A1 2002/0007009 and EP-A1 2676976 employ aqueous dispersions or water-redispersible powders of water-insoluble copolymers having silane and epoxide monomer units in paints. Such aqueous dispersions of water-insoluble copolymers are employed in EP-B1 3066255 as binders for textile fabrics.

Suspension or emulsion polymers are naturally insoluble in water. In construction material dry mixes modified accordingly, however, polymer powders have to be dispersed when the mixes are made up with water. This generally takes time or requires relatively intensive mixing and the use of auxiliaries, such as protective colloids. Nevertheless, such auxiliaries are generally of increased water solubility and may be detrimental to the water resistance of construction products.

Polymers in the form of water-redispersible powders, as is known, are polymer compositions which are accessible by drying of the corresponding aqueous polymer dispersions in the presence of drying assistants. On the basis of this production process, the finely divided polymer resin of the dispersion is enveloped with customary water-soluble drying assistants. During drying, the drying assistant acts like a cloak, preventing the particles from sticking together irreversibly. On redispersing the polymer powders in water, the drying assistant dissolves, and an aqueous redispersion is formed in which as far as possible the original polymer particles (primary polymer particles) are present again (Schulze J. in TIZ, No. 9, 1985).

Against this background, the object remained of providing construction products, such as tile adhesives, joint fillers or mortars for thermal insulation composite systems, having improved mechanical strengths, more particularly improved adhesive tensile strengths after water storage. Additives employed for these purposes, moreover, ought to be readily soluble in water, to allow the additives to be introduced in a time-efficient manner into aqueous construction material mixes.

A subject of the invention are construction material dry mixes containing one or more hydraulically setting binders, one or more fillers and optionally one or more additives, characterized in that
they contain one or more water-soluble solid vinyl ester resins, obtainable by solution polymerization or bulk polymerization of
   a) one or more vinyl esters of carboxylic acids having 1 to 20 carbon atoms,
   b) 0.1% to 20% by weight of one or more ethylenically unsaturated monomers containing silane groups (silane monomers), and
   c) 0.5% to 20% by weight of one or more ionic, ethylenically unsaturated monomers (ionic monomers,
where the figures in % by weight are each based on the total weight of the solid vinyl ester resins.

A further subject of the invention are water-soluble solid vinyl ester resins, obtainable by solution polymerization or bulk polymerization of
a) one or more vinyl esters of carboxylic acids having 1 to 20 carbon atoms,
b) 0.1% to 20% by weight of one or more ethylenically unsaturated monomers containing silane groups (silane monomers), and
c) 0.5% to 20% by weight of one or more ionic, ethylenically unsaturated monomers (ionic monomers),
   where the figures in % by weight are each based on the total weight of the water-soluble solid vinyl ester resins.

The water-soluble solid vinyl ester resins are also referred to below for short as solid vinyl ester resins.

Solution and bulk polymerizations, and the solid resins obtainable thereby, are fundamentally different, implicitly, from emulsion and suspension polymerizations and their polymerization products. Emulsion and suspension polymerizations belong to the category of heterophase polymerizations and are generally characterized in that the monomers, and the polymers formed during the polymerization, are insoluble in the continuous phase, i.e., in the polymerization medium, generally water, and in that consequently, for stabilization, polymerization takes place in the presence of emulsifiers or protective colloids, and in that, as a consequence of this, the polymerization products migrate into micelles, in which the polymers form particulate polymer coils or latex particles, or polymer beads, or polymer particles, the surface thereof carrying emulsifiers or protective colloids. In the specific case of emulsifier-free emulsion polymerization, the initiator carries specific groups, often charged groups, which then form the stabilizing system for the heterophase. In emulsion and suspension polymerization, polar, protic or ionic monomers and initiators behave similarly to emulsifiers and protective colloids and consequently, in emulsion or suspension polymers, are found substantially on the surface of the emulsion and suspension polymerization polymer particles. Conversely, in the case of solution and bulk polymerizations, the monomers and also the polymers are implicitly soluble in the polymerization medium, i.e., the solvent or the monomers. Accordingly, in the case of solution and bulk polymerizations, it is customary not to use emulsifiers and protective colloids. As a result of their solubility in the polymerization medium, the solution polymers are generally present in the form of dissolved polymer strands and not, like emulsion and suspension polymers, in the form of latex particles or polymer particles. In solution and bulk polymers, furthermore, the different monomers, including ionic monomers in particular, are implicitly incorporated with uniform distribution into the polymer chains and, unlike emulsion and suspension polymers, are not located preferentially at the surface of polymer particles. As a result, solution and bulk polymers implicitly differ structurally from emulsion or suspension polymers.

Suitable vinyl esters a) are those of carboxylic acids having 1 to 20 carbon atoms, more particularly 2 to 15 carbon atoms, such as, for example, vinyl acetate, vinyl propionate, vinyl butyrate, vinyl 2-ethylhexanoate, vinyl laurate, 1-methylvinyl acetate, vinyl pivalate and vinyl esters of a-branched monocarboxylic acids having 9 to 11 carbon atoms. Particularly preferred is vinyl acetate.

Also preferred are combinations of vinyl acetate and one or more other vinyl esters different from vinyl acetate, such as vinyl propionate, vinyl butyrate, vinyl 2-ethylhexanoate, 1-methylvinyl acetate, more particularly vinyl laurate, vinyl pivalate or vinyl esters of a-branched monocarboxylic acids having 9 to 11 carbon atoms.

The solid vinyl ester resins are based on preferably 60% to 99.4%, more preferably 80% to 98.5% and most preferably 87% to 97% by weight of vinyl esters a), based in each case on the total weight of the solid vinyl ester resins.

Examples of silane monomers b) are unsaturated silicon compounds of the general formula R¹SiR²₀₋₂ (OR³)₁₋₃, where the definition of R¹ is CH₂═CR⁴—(CH₂)₀₋₁ or CH₂═CR⁴CO₂(CH₂)₁₋₃, the definition of R² is C₁ to C₃ alkyl radical, C₁ to C₃ alkoxy radical or halogen, preferably Cl or Br, R³ is an unbranched or branched, optionally substituted alkyl radical having 1 to 12 carbon atoms, preferably 1 to 3 carbon atoms, or is an acyl radical having 2 to 12 carbon atoms, where R³ may optionally be interrupted by an ether group, and R⁴ is H or CH₃.

Preferred silane monomers b) are γ-acryl- and γ-methacryloxypropyltri(alkoxy)silanes, α-methacryloxymethyltri(alkoxy)silanes, γ-methacryloxypropyl-methyldi(alkoxy)silanes; vinylsilanes such as vinylalkyldi(alkoxy)silanes and vinyltri(alkoxy)silanes, in which alkoxy groups used may be, for example, methoxy, ethoxy, methoxyethylene, ethoxyethylene, methoxypropylene glycol ether and/or ethoxypropylene glycolether radicals.

Examples of preferred silane monomers b) are 3-methacryloxypropyltrimethoxysilane, 3-methacryloxypropylmethyldimethoxysilane, vinyltrimethoxysilane, vinylmethyldimethoxysilane, vinyltriethoxysilane, vinylmethyldiethoxysilane, vinyltripropoxysilane, vinyltriisopropoxysilane, vinyltris-(1-methoxy)-isopropoxysilane, vinyltributoxysilane, vinyltriacetoxysilane, methacryloxymethyltrimethoxysilane, 3-methacryloxypropyl-tris(2-methoxyethoxy)silane, vinyltrichlorosilane, vinylmethyldichlorosilane, vinyltris-(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmethoxydilauryloxysilane, vinyldimethoxylauryloxysilane and also polyethyleneglycol-modifizierte vinylsilanes.

The most-preferred silane monomers b) used are vinyltrimethoxysilane, vinylmethyldimethoxysilane, vinyltriethoxysilane, vinylmethyldiethoxysilane, vinyltris(1-methoxy)-isopropoxysilane, methacryloxypropyltris(2-methoxyethoxy)silane, 3-methacryloxypropyltrimethoxysilane, 3-methacryloxypropylmethyldimethoxysilane and methacryloxymethyltrimethoxysilane and also mixtures thereof.

Suitable silane monomers b) are also (meth)acrylamides containing silane groups, of the general formula CH₂═CR⁵—CO—NR⁶—R⁷—SiR⁸n—(R⁹)₃₋ₘ, where n=0 to 4, m=0 to 2, R⁵ is either H or a methyl group, R⁶ is H or an alkyl group having 1 to 5 carbon atoms; R⁷ is an alkylene group having 1 to 5 carbon atoms or is a divalent organic group in which the carbon chain is interrupted by an O or N atom, R⁸ is an alkyl group having 1 to 5 carbon atoms, R⁹ is an alkoxy group having 1 to 40 carbon atoms which may be substituted by further heterocycles. In monomers in which 2 or more R⁵ or R⁹ groups occur, these groups may be identical or different.

Examples of such (meth)acrylamidoalkylsilanes are the following: 3-(meth)-acrylamidopropyltrimethoxysilane, 3-(meth)acrylamidopropyltriethoxysilane, 3-(meth)acrylamido-propyltri (ß-methoxyethoxy)silane, 2-(meth)acrylamido-2-methylpropyltrimethoxysilane, 2-(meth)acrylamido-2-methylethyltrimethoxysilane, N-(2-(meth)acrylamido-ethyl)aminopropyltrimethoxysilane, 3-(meth)acrylamido-propyltriacetoxysilane, 2-(meth)acrylamidoethyltrimethoxysilane, 1-(meth)acrylamidomethyltrimethoxysilane, 3-(meth)- acrylamidopropylmethyldimethoxysilane, 3-(meth)acrylamidopropyldi-methylmethoxysilane, 3-(N-methyl(meth)acrylamido)propyltrimethoxysilane, 3-((meth)acrylamidomethoxy)-3-hydroxypropyltrimethoxysilane, 3-((meth)acrylamidomethoxy) propyltrimethoxysilane, N,N-dimethyl-N-trimethoxysilyl-propyl-3-(meth)acrylamidopropylammonium chloride and N-N-dimethyl-N-tri-methoxysilylpropyl-2-(meth)acrylamido-2-methylpropylammonium chloride.

Preference is given overall to vinylsilanes, in other words silanes containing vinyl groups.

The solid vinyl ester resins are based on preferably 0.5% to 10%, more preferably 1% to 7% and most preferably 1% to 5% by weight of silane monomers b), based in each case on the total weight of the solid vinyl ester resins.

The solid vinyl ester resins are based on preferably 1% to 10%, more preferably 2% to 6% and most preferably 3% to 5% by weight of ionic monomers c), based in each case on the total weight of the solid vinyl ester resins.

The ionic monomers c) may be cationic ethylenically unsaturated monomers (cationic monomers) or, preferably, anionic ethylenically unsaturated monomers (anionic monomers).

Examples of anionic monomers c) are ethylenically unsaturated monomers which additionally carry, for example, a carboxylic acid, sulfonic acid, sulfate or phosphonic acid group. Monomers carrying sulfonic acid groups are preferred.

Ethylenically unsaturated carboxylic acids may be, for example, monocarboxylic or dicarboxylic acids, preferably acrylic acid, methacrylic acid, itaconic acid, fumaric acid, maleic acid, and monoesters and diesters of fumaric acid and maleic acid, such as the diethyl and diisopropyl esters. Examples of ethylenically unsaturated sulfonic acids are methallyl sulfonate, vinylsulfonic acid, 2-acrylamido-2-methyl-propanesulfonic acid (AMPS), styrenesulfonic acid, sulfoalkyl (meth)acrylates, sulfoalkyl itaconates, preferably in each case with C₁-to C₆ alkyl radical, vinylsulfonic acid.

Particularly preferred for use are methallyl sulfonate, 2-acrylamido-2-methylpropanesulfonic acid (AMPS), styrenesulfonic acid, sulfopropyl acrylate, sulfopropyl itaconate, and vinylsulfonic acid.

The most-preferred monomers c) are acrylic acid, methacrylic acid, vinylsulfonic acid and methallyl sulfonate.

The anionic monomers c) may also take the form of their salts, as for example their alkali metal, alkaline earth metal or ammonium salts, preferably sodium, potassium, calcium or ammonium salts.

Examples of cationic monomers c) are diallyldiethylammonium chloride (DADEAC), (3-methacryloxy)propyltrimethylammonium chloride (MPTAC), (3-methacryloxy)-ethyltrimethylammonium chloride (METAC), (3-methacrylamido)propyltrimethylammonium chloride (MAPTAC), trimethyl-3-(1-acrylamido-1,1-dimethylpropyl)ammonium chloride, trimethyl-3-(1-acrylamido-1,1-dimethylbutyl)ammonium chloride, dimethylacrylamidopropyl-4-trimethylammonium butenyl-2-ammonium chloride, 2-acrylamidomethoxy)ethyltrimethylammonium chloride and especially diallyldimethylammonium chloride (DADMAC).

Preferred cationic monomers c) are diallyldimethylammonium chloride (DADMAC), diallyldiethylammonium chloride (DADEAC), (3-methacryloxy)propyltrimethylammonium chloride (MPTAC), (3-methacryloxy)ethyltrimethylammonium chloride (METAC) and (3-methacrylamido)propyltrimethylammonium chloride (MAPTAC).

The solid vinyl ester resins may optionally be based on one or more further ethylenically unsaturated monomers different from the monomers a) to c), examples being ethylenically unsaturated monomers d) or auxiliary monomers.

The monomers d) are preferably selected from the group encompassing (meth)acrylic esters, vinylaromatics, olefins, 1,3-dienes and vinyl halides.

Suitable monomers from the group of the esters of acrylic acid or methacrylic acid are, for example, esters of unbranched or branched alcohols having 1 to 15 carbon atoms, such as, for example, methyl acrylate, methyl methacrylate, ethyl acrylate, ethyl methacrylate, propyl acrylate, propyl methacrylate, n-butyl acrylate, n-butyl methacrylate, and 2-ethylhexyl acrylate.

Examples of vinylaromatics are styrene, methylstyrene and vinyltoluene. An example of vinyl halide is vinyl chloride. Examples of olefins are ethylene and propylene. Examples of dienes are 1,3-butadiene and isoprene.

The solid vinyl ester resins are preferably based to an extent of 0% to 50%, more preferably 1% to 40%, more preferably still 2% to 30% and very preferably 5% to 20% by weight on monomers d), based on the total weight of the solid vinyl ester resins. The most-preferred solid vinyl ester resins contain no units of monomers d).

Additionally there may optionally be one or more ethylenically unsaturated auxiliary monomers e) copolymerized. Examples of auxiliary monomers e) are ethylenically unsaturated carboxamides and carbonitriles, preferably acrylamide and acrylonitrile; diesters of fumaric acid and maleic acid, such as the diethyl and diisopropyl esters, and maleic anhydride; and acetylacetoxyethyl acrylate or methacrylate. Auxiliary monomers e) may also be ethylenically unsaturated crosslinking monomers e), such as precrosslinking or postcrosslinking monomers e). Examples of precrosslinking monomers e) are polyethylenically unsaturated monomers, as for example divinyl adipate, diallyl maleate, allyl methacrylate, triallyl isocyanurate or triallyl cyanurate. Examples of postcrosslinking monomers e) are monomers with epoxide functionality, such as glycidyl methacrylate and glycidyl acrylate. Other such monomers include those with hydroxyl groups, such as hydroxyalkyl acrylates and methacrylates, more particularly hydroxyethyl, hydroxypropyl or hydroxybutyl acrylate or methacrylate. The auxiliary monomers e) are generally different from the aforementioned monomers a) to d) or a) to c), in particular also different from the aforementioned monomers a).

The solid vinyl ester resins are preferably based to an extent of 0% to 20%, more preferably 0.5% to 10% and very preferably 1% to 5% by weight on auxiliary monomers e), based on the total weight of the solid vinyl ester resins.

Preference is also given to solid vinyl ester resins which contain no units of monomers containing hydroxyl or carboxylic anhydride groups. Particularly preferred are solid vinyl ester resins which contain no units of N-methylol(meth)acrylamide. The solid vinyl ester resins also preferably contain no units of N-(alkoxymethyl)(meth)acrylamides, such as N-(isobutoxymethyl)acrylamide (IBMA), N-(isobutoxymethyl)methacrylamide (IBMMA), N-(n-butoxymethyl)acrylamide (NBMA) or N-(n-butoxy-methyl)methacrylamide (NBMMA). The most-preferred solid vinyl ester resins contain no units of crosslinking monomers e), more particularly no monomer units with epoxide functionality. Solid vinyl ester resins that are the very most preferred contain no units of auxiliary monomers e).

The Höppler viscosity of the solid vinyl ester resins is preferably 0.1 to 100 mPas, more preferably 0.5 to 50 mPas and most preferably 1 to 10 mPas (determined according to DIN 53015, Höppler method, at 20° C., 4% aqueous solution).

The solid vinyl ester resins at 23° C. have a solubility in water of preferably at least 3%, more preferably at least 5%, very preferably at least 10% and most preferably at least 15% by weight.

The various monomers a) to c) are preferably incorporated randomly or homogeneously into the solid vinyl ester resins.

The solid vinyl ester resins preferably take the form of solutions in organic solvents or more preferably aqueous solutions, or a solid form. The solutions are preferably clear, but may possibly also have some turbidity, but generally do not take the form of dispersions. Thus solutions with a solid vinyl ester resin solids content of 20% by weight have a turbidity of preferably ≤700 EBC, more preferably ≤600 EBC, more preferably still ≤400 EBC and most preferably ≤200 EBC (determined as per formazin standard according to DIN 38404 at room temperature with the turbidity instrument from Metrisa: model TA6FS/model 251).

A further subject of the invention are processes for preparing the water-soluble solid vinyl ester resins by means of radically initiated solution polymerization or bulk polymerization of
a) one or more vinyl esters of carboxylic acids having 1 to 20 carbon atoms,
b) 0.1% to 20% by weight of one or more ethylenically unsaturated monomers containing silane groups (silane monomers), and
c) 0.5% to 20% by weight of one or more ionic, ethylenically unsaturated monomers (ionic monomers),
   where the figures in % by weight are each based on the total weight of the water-soluble solid vinyl ester resins.

The solid vinyl ester resins are prepared preferably by the solution polymerization process.

The solution polymerization is carried out preferably in one or more organic solvents. Examples of organic solvents are alcohols, especially glycols, polyethylene glycol or aliphatic alcohols having 1 to 6 carbon atoms; ketones, especially acetone or methyl ethyl ketone; esters, especially methyl acetate, ethyl acetate, propyl acetate or butyl acetate; or ethers. Preferred organic solvents are methanol, isopropanol, methyl acetate, ethyl acetate and butyl acetate.

Solvent mixtures may also be employed. Solvent mixtures contain preferably one or more organic solvents. Possible solvent mixtures contain preferably ≤20%, more preferably ≤10% and very preferably ≤5% by weight of water, based on the total weight of the solvent mixtures. Most preferably, solvent mixtures contain no water. With the most preference of all, no water is used or no water is present during solution polymerization or bulk polymerization.

The solution polymerization or bulk polymerization may be initiated using typical thermally activated initiators or redox initiator combinations. Examples of suitable radical initiators are oil-soluble initiators, such as t-butyl peroxy-2-ethylhexanoate, t-butyl peroxypivalate, t-butyl peroxyneodecanoate, dibenzoyl peroxide, t-amyl peroxypivalate, di(2-ethylhexyl) peroxydicarbonate, 1,1-bis(t-butylperoxy)-3,3,5-trimethylcyclohexane and di(4-t-butylcyclohexyl) peroxydicarbonate. Also suitable are azo initiators, such as azobisisobutyronitrile. The initiators are used generally in an amount of 0.005% to 3.0%, preferably of 0.01% to 1.5%, by weight, based in each case on the total weight of the monomers for preparing the vinyl acetate-isopropenyl acetate copolymers.

The temperature during the polymerization is preferably 20° C. to 160° C., more preferably 40° C. to 140° C. Polymerization is conducted generally under atmospheric pressure, preferably under reflux.

To control the molecular weight, regulator substances may be used during the polymerization processes. If regulators, in the form of chain transfer agents, are used, they are used customarily in amounts of between 0.01% to 5.0% by weight, based on the monomers to be polymerized, and for example are metered separately or else as a premix with reaction components. Examples of such agents are n-dodecyl mercaptan, tert-dodecyl mercaptan, mercaptopropionic acid, methyl mercaptopropionate, isopropanol and acetaldehyde. With preference no chain transfer agents are used.

The polymerization processes may also be carried out in the presence of emulsifiers or protective colloids. Preferred amounts of emulsifiers and protective colloids are up to 10%, more particularly 0.1% to 10%, by weight, based on the total weight of the monomers. With particular preference, polymerization is conducted in the absence of emulsifiers and/or in particular in the absence of protective colloids.

The solutions and/or solids of the solid vinyl ester resins are preferably free from emulsifiers and/or in particular free from protective colloids.

Examples of emulsifiers are anionic, cationic or nonionic emulsifiers, such as anionic surfactants, more particularly alkyl sulfates, alkyl- or alkylaryl ether sulfates, alkyl- or alkylarylsulfonates, sulfosuccinic (mono) esters, or nonionic surfactants such as alkyl polyglycol ethers or alkylaryl polyglycol ethers having 8 to 40 ethylene oxide units. Examples of protective colloids are polyvinyl alcohols; polyvinyl acetals; polyvinylpyrrolidones; polysaccharides in water-soluble form such as starches (amylose and amylopectin), celluloses and their carboxymethyl, methyl, hydroxyethyl and hydroxypropyl derivatives, dextrins und cyclodextrins; proteins such as casein or caseinate, soy protein, gelatine; lignosulfonates; synthetic polymers such as poly(meth)acrylic acid, co-polymers of (meth)acrylates with carboxyl-functional comonomer units, poly(meth)acrylamide, polyvinylsulfonic acids and water-soluble copolymers thereof; melamine-formaldehydesulfonates, naphthalene-formaldehydesulfonates, styrene-maleic acid and vinyl ether-maleic acid copolymers. Protective colloids are more particularly polyvinyl alcohols such as partially hydrolyzed polyvinyl alcohols, cellulose ethers such as methyl-, methylhydroxypropyl-and hydroxyethyl-cellulose, and carboxymethyl-celluloses.

The polymerization may be carried out by a batch process, where all of the components are included in the initial reactor charge, or by a metering process, where individual or multiple components are fed in during the polymerization. Hybrid modes with initial charge and metering are preferred. The metered feeds may be made separately (in space and in time), or some or all of the components for metering may be metered in after prior emulsification.

In the case of the solution polymerization process, the polymerization is taken generally to a solids content of 10% to 70%, preferably to a solids content of 15% to 60%, by weight.

On conclusion of the polymerization, residual monomers may be removed by post-polymerization employing known methods-for example, by post-polymerization initiated with redox catalyst. Volatile residual monomers may also be removed by distillation or stripping methods, preferably under reduced pressure, and optionally with inert entraining gases, such as air, nitrogen or steam, being passed through or over the product.

To convert the polymers into solid vinyl ester resins in solid form, the solutions thereof may be dried in a conventional manner, via distillation to the melt, fluidized bed drying, roll drying, freeze drying or spray drying, for example. The solutions are preferably spray-dried. With particular preference, volatile residual monomers or other volatile constituents, such as solvents, are removed distillatively, preferably under reduced pressure.

To improve the performance properties, the solid vinyl ester resins may be blended with adjuvants, such as pigments, fillers, antiblocking agents, redispersible polymer powders, foam stabilizers or hydrophobizing agents, for example.

A further subject of the invention are polymer compositions containing one or more protective colloid- or emulsifier-stabilized polymers based on ethylenically unsaturated monomers (base polymers) in the form of aqueous dispersions or water-redispersible powders, characterized in that they contain one or more water-soluble solid vinyl ester resins of the invention.

With polymer compositions of these kinds, the object of the invention can be achieved even more effectively; in particular, the mechanical properties of construction products can be improved.

The polymer compositions contain preferably 1% to 80%, more properly 5% to 60% and most preferably 10% to 40% by weight of solid vinyl ester resins, based on the dry weight of the polymer compositions.

The polymer compositions contain preferably 20% to 99%, more preferably 40% to 95% and most preferably 60% to 90% by weight of protective colloid- or emulsifier-stabilized base polymers, based on the dry weight of the polymer compositions.

The polymer compositions are preferably in the form of aqueous dispersions or in the form of water-redispersible powders.

In the polymer compositions, the base polymers and the solid vinyl ester resins take the form preferably of a mere blend.

The base polymers are preferably water-insoluble. The base polymers at 23° C. have a solubility in water of preferably at most 1%, more preferably at most 0.9%, by weight. The solubility properties of polymers are dependent, for example, on their monomer composition. The skilled person is able to provide water-insoluble or water-soluble polymers on the basis of a few rangefinding tests.

The base polymers are based preferably on one or more monomers from the group encompassing vinyl esters of unbranched or branched carboxylic acids having 1 to 18 carbon atoms, esters of acrylic acid and methacrylic acid with unbranched or branched alcohols having 1 to 18 carbon atoms, vinylaromatics, vinyl halides and olefins.

These monomers may assume the preferred and particularly preferred embodiments indicated above.

The base polymers are generally different from the water-soluble copolymers of the invention. The base polymers preferably contain no silane monomer units b).

The base polymers are based to an extent of preferably ≥80%, more preferably ≥90%, more preferably still ≥95%, very preferably ≥98%, more preferably still ≥99% and most preferably ≥99.5% by weight on the aforementioned monomers a) and d), based on the total weight of the base polymers. With the greatest preference of all, the base polymers are based exclusively on the aforementioned monomers a) and d).

Examples of suitable base polymers are vinyl acetate homopolymers, copolymers of vinyl acetate with ethylene, copolymers of vinyl acetate with ethylene and one or more further vinyl esters, copolymers of vinyl acetate with ethylene and acrylic ester, copolymers of vinyl acetate with ethylene and vinyl chloride, styrene-acrylic ester copolymers and styrene-1,3-butadiene copolymers.

Preferred are vinyl acetate homopolymers; copolymers of vinyl acetate with 1% to 40% by weight of ethylene; copolymers of vinyl acetate with 1% to 40% by weight of ethylene and 1% to 50% by weight of one or more further comonomers from the group of vinyl esters having 1 to 12 carbon atoms in the carboxylic acid radical, such as vinyl propionate, vinyl laurate, vinyl esters of alpha-branched carboxylic acids having 5 to 13 carbon atoms, such as VeoVa9R, VeoVa10R, VeoVa11R; copolymers of vinyl acetate, 1% to 40% by weight of ethylene and preferably 1% to 60% by weight of acrylic esters of unbranched or branched alcohols having 1 to 15 carbon atoms, especially n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 5 to 13 carbon atoms, and also 1% to 30% by weight of acrylic esters of unbranched or branched alcohols having 1 to 15 carbon atoms, especially n-butyl acrylate or 2-ethylhexyl acrylate, which may also contain 1% to 40% by weight of ethylene; copolymers with vinyl acetate, 1% to 40% by weight of ethylene 1% to 60% by weight of vinyl chloride; where the polymers may also contain the stated auxiliary monomers in the stated amounts and where the figures in % by weight add up to 100% by weight in each case.

Also preferred are (meth)acrylic ester polymers, such as copolymers of n-butyl acrylate or 2-ethylhexyl acrylate or copolymers of methyl methacrylate with n-butyl acrylate and/or 2-ethylhexyl acrylate and optionally ethylene; styrene-acrylic ester copolymers with one or more monomers of the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; where the polymers may also contain the stated auxiliary monomers in the stated amounts and where the figures in % by weight add up to 100% by weight in each case.

The monomer selection and the selection of the weight fractions of the comonomers for the base polymers are made such as in general to result in a glass transition temperature Tg of −50° C. to +50° C., preferably of −30° C. to +40° C. The glass transition temperature Tg of the polymers may be ascertained in a known manner via Differential Scanning calorimetry (DSC). The Tg may also be calculated approximately in advance by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in kelvins of the homopolymer of the monomer n. Tg values for homopolymers are listed in Polymer Handbook, 2nd edition, J. Wiley & Sons, New York (1975).

The preparation of the base polymers in the form of aqueous dispersions or water-redispersible powders takes place generally via radically initiated polymerization of ethylenically unsaturated monomers by the suspension or emulsion polymerization process in the presence of protective colloids and/or emulsifiers, and optional subsequent drying.

The aforementioned protective colloids and/or emulsifiers may be employed. Otherwise, the preparation of the base polymers and their drying may take place in a conventional manner, as described for example in DE-A 102006007282.

The construction material dry mixes contain hydraulically setting binders; fillers; water-soluble solid vinyl ester resins and optionally one or more protective colloid- or emulsifier-stabilized polymers based on ethylenically unsaturated monomers (base polymers) in the form of water-redispersible powders; and optionally additives.

Water-soluble solid vinyl ester resins and protective colloid-or emulsifier-stabilized polymers based on ethylenically unsaturated monomers (base polymers) in the form of water-redispersible powders are introduced preferably in the form of a premix-that is, preferably in the form of the polymer compositions of the invention-into the construction material dry mixes.

The construction material dry mixes contain preferably 0.1% to 50%, more preferably 1% to 20% and most preferably 3% to 10% by weight of water-soluble solid vinyl ester resins, based in each case on the dry weight of the construction material dry mixes.

The construction material dry mixes contain preferably 0.1% to 30%, more preferably 0.3 to 12.0% and most preferably 0.5% to 5.0% by weight of polymer compositions of the invention, based in each case on the dry weight of the construction material dry mixes.

Suitable hydraulically setting binders are, for example, cements, especially portland cement, aluminate cement, trass cement, slag cement, magnesia cement, phosphate cement or blast furnace cement, and also mixed cements, filling cements, fly ash, microsilica, hydraulic lime, and gypsum. Preference is given to portland cement and slag cement, and also to mixed cements, filling cements, hydraulic lime, and gypsum, and especially to aluminate cement. Also preferred are combinations of aluminate cement and one or more further hydraulically setting binders.

In general, the construction material dry mixes contain 5% to 50%, preferably 10% to 30%, by weight of hydraulically setting binders, based in each case on the dry weight of the construction material dry mixes.

Examples of suitable fillers are quartz sand, quartz powder, calcium carbonate, dolomite, aluminum silicates, clay, chalk, white hydrated lime, talc or mica, or else light-weight fillers such as pumice, foam glass, aerated concrete, perlite, vermiculite, and carbon nanotubes (CNTs). Any desired mixtures of the stated fillers may also be used. Preference is given to quartz sand, quartz powder, calcium carbonate, chalk or white hydrated lime.

In general, the construction material dry mixes contain 30% to 90%, preferably 40% to 85%, by weight of fillers, based in each case on the dry weight of the construction material dry mixes.

Additives for the construction material dry mixes are, for example, thickeners, examples being polysaccharides such as cellulose ethers and modified cellulose ethers, starch ethers, guar gum, xanthan gum, phyllosilicates, polycarboxylic acids such as polyacrylic acid and partial esters thereof, and also polyvinyl alcohols, which may optionally have been acetalized or hydrophobically modified, casein, and associative thickeners. Other customary additives are retarders, such as hydroxycarboxylic acids, or dicarboxylic acids or salts thereof, saccharides, oxalic acid, succinic acid, tartaric acid, gluconic acid, citric acid, sucrose, glucose, fructose, sorbitol and pentaerythritol. Setting accelerators are a customary additive, examples being alkali metal salts or alkaline earth metal salts of organic or inorganic acids. Further additives include the following: hydrophobizing agents, preservatives, film-forming assistants, dispersants, foam stabilizers, defoamers and flame retardants (e.g., aluminum hydroxide).

The additives are used in the customary amounts for them, which depend on the nature of the adjuvant. The amounts are preferably 0% to 15%, more particularly 0.01% to 10%, by weight, based in each case on the dry weight of the construction material dry mixes.

The construction material dry mixes are generally produced by mixing hydraulically setting binders, fillers, water-soluble solid vinyl ester resins and/or polymer compositions and optionally additives. The construction material dry mixes may be produced by inherently conventional procedures in conventional apparatuses. The amount of water needed for processing the construction material dry mixes is customarily added directly prior to application.

The construction material dry mixes are suitable, for example, for producing reinforcing compounds for thermal insulation composite systems or for producing bonding agents or coating materials. Examples of bonding agents are bonding agents for thermal insulation boards and soundproofing boards, tile adhesives, and bonding agents for bonding wood and woodbase materials. Examples of coating materials are mortars, leveling compounds, screeds and renders. The construction material dry mixes are used with particular preference as tile adhesives, as joint fillers or as adhesives for thermal insulation composite systems.

The water-soluble solid vinyl ester resins of the invention and/or the polymer compositions of the invention are also suitable as binders in mortars, filling compounds, leveling compounds, renders, construction adhesives or sealing slurries.

Application products with the water-soluble solid vinyl ester resins of the invention feature surprising performance properties, such as, for example, advantageous mechanical strengths, particularly high adhesive tensile strengths, and even a very high water resistance. Construction products with the water-soluble solid vinyl ester resins are more stable after thermal load or after storage with alternating freeze/thaw, and also have less of a tendency to effloresce after water storage by comparison with corresponding construction products containing conventional protective colloids. The water-soluble solid vinyl ester resins can be used to counteract cracking in construction products. Advantageously, the water-soluble solid vinyl ester resins are also notable for high cement compatibility and high adhesion to mineral construction material compounds.

Another particularly advantageous feature is the water solubility of the solid vinyl ester resins of the invention, even when no protective colloids or emulsifiers are used. In the invention, it is possible to eliminate any effect of such stabilizing systems on the viscosities, the rheology or, generally, the processing properties of fresh mortars, or on the properties of cured construction products, such as wet adhesive tensile strength. As a result, construction material dry mixes containing water-soluble solid vinyl ester resins can be made up rapidly and time-efficiently with water and processed in a conventional and simple manner.

The examples below serve for further elucidation of the invention:

### Preparation of Solid Resins

### Inventive Example 1:

Solid polyvinyl acetate resin with 5% by weight of sulfonate monomers and 2.5% by weight of silane monomers:

A 2 I stirred glass vessel with anchor stirrer, reflux condenser and metering devices was charged with 109.5 g of vinyl acetate, 14.8 g of a 40% MLSA solution (methallylsulfonate), 3.0 g of Geniosil GF56, 0.6 g of TBPPI (t-butyl peroxypivalate, 75% solution in aliphatics) and 164.2 g of methanol. At a stirrer speed of 150 rpm, the initial charge was then heated under nitrogen to 70° C. On attainment of the internal temperature of 70° C., 620.7 g of vinyl acetate, 16.8 g of Geniosil GF56, 83.9 g of Geropon MLSA solution and 3.8 g of 75% TBPPI (solution in aliphatics) in 39.5 g of methanol were metered in. The monomer solution was metered in over the course of 240 minutes and the initiator solution over the course of 300 minutes. After the end of the initiator feeds, polymerization was continued for 5 hours at 80° C. Volatile constituents were removed under reduced pressure.

The Höppler viscosity of the copolymer (10% by weight in water at 20° C.) was 3.2 mPas.

### Inventive Example 2:

Solid polyvinyl acetate resin with 5% by weight of sulfonate monomers and 5% by weight of silane monomers:

A 2 I stirred glass vessel with anchor stirrer, reflux condenser and metering devices was charged with 163.4 g of methanol and 0.6 g of TBPPI (t-butyl peroxypivalate, 75% solution in aliphatics). At a stirrer speed of 150 rpm, the initial charge was then heated under nitrogen to 70° C. On attainment of the internal temperature of 70° C., 706.8 g of vinyl acetate, 98.2 g of 40% MLSA solution, 39.3 g of Geniosil GF56 and 3.8 g of 75% TBPPI (solution in aliphatics) in 39.3 g of methanol were metered in. The monomer solution was metered in over the course of 240 minutes and the initiator solution over the course of 300 minutes. After the end of the initiator feeds, polymerization was continued for 5 hours at 80° C. Volatile constituents were removed under reduced pressure.

The Höppler viscosity of the copolymer (10% by weight in water at 20° C.) was 4.4 mPas.

### Comparative Example 1:

Solid polyvinyl acetate resin with 5% by weight of sulfonate monomer but no silane monomer:

A 2 I stirred glass vessel with anchor stirrer, reflux condenser and metering devices was charged with 165.0 g of methanol and 0.6 g of TBPPI (t-butyl peroxypivalate, 75% solution in aliphatics). At a stirrer speed of 150 rpm, the initial charge was then heated under nitrogen to 70° C. On attainment of the internal temperature of 70° C., 753.8 g of vinyl acetate, 99.2 g of 40% MLSA solution and 3.8 g of 75% TBPPI (solution in aliphatics) in 39.7 g of methanol were metered in. The monomer solution was metered in over the course of 240 minutes and the initiator solution over the course of 300 minutes. After the end of the initiator feeds, polymerization was continued for 5 hours at 80° C. Volatile constituents were removed under reduced pressure.

The Höppler viscosity of the copolymer (10% by weight in water at 20° C.) was 2.2 mPas.

### Comparative Example 2:

Solid polyvinyl acetate resin with no sulfonate monomer, with 2.5% by weight of silane monomers:

A 2 I stirred glass vessel with anchor stirrer, reflux condenser and metering devices was charged with 109.5 g of vinyl acetate, 2.8 g of Geniosil GF56, 0.6 g of TBPPI (t-butyl peroxypivalate, 75% solution in aliphatics) and 163.2 g of methanol. At a stirrer speed of 150 rpm, the initial charge was then heated under nitrogen to 70° C. On attainment of the internal temperature of 70° C., 601.2 g of vinyl acetate, 14.6 g of Geniosil GF56 and 3.7 g of 75% TBPPI (solution in aliphatics) in 39.5 g of methanol were metered in. The monomer solution was metered in over the course of 240 minutes and the initiator solution over the course of 300 minutes. After the end of the initiator feeds, polymerization was continued for 5 hours at 80° C. Volatile constituents were removed under reduced pressure.

The Höppler viscosity of the copolymer (10% by weight in ethyl acetate at 20° C.) was 6.8 mPas.

### Comparative Example 3:

Hydrolyzed solid polyvinyl acetate resin:

The solid polyvinyl acetate resin from Inventive example 1 was hydrolyzed as follows:

A 2I stirred glass vessel with anchor stirrer, reflux condenser and metering devices was charged with 1403.8 g of a 69.5% methanolic resin solution (solid polyvinyl acetate resin from Inventive example 1) and 395.3 g of methanol. The solution was heated to 30° C. and overlayered with a solution of 7.3 g of 46% sodium hydroxide solution in 140.3 g of methanol. The stirrer was then switched to 200 rpm and hydrolysis took place for 2 h.

During the hydrolysis, the copolymer underwent irreversible gelling, the gel being no longer completely soluble even by dilution with methanol or water; this gel could not be used as a water-soluble polymer.

### Testing of Water Suitability of the Solid Polyvinyl Acetate Resins

Inventive example 1: soluble in water to at least 20% by weight
Inventive example 2: soluble in water to at least 20% by weight

### Testing of the Solid Resins as Sole Binder

The solid resins from each of the inventive and comparative examples were tested as binders for fillers.

This was done by mixing 5% by weight of the relevant solid resin as a 20% by weight aqueous solution with sand, establishing a pH of 9-10 and drying the resulting mixture as a layer 3 mm thick overnight (16 hours) under standard conditions (23° C., 50% relative humidity). This was followed by testing of the water resistance, as reported in table 1.

TABLE 1
Testing of solid resins as binders for fillers:

| Solid | |
|---|---|
| resin | Strength of test specimen subject to water storage |
| Inv. 1 | Specimen water-resistant: |
| | Structure of test specimen retained over several days |
| Inv.2 | Specimen water-resistant: |
| | Structure of test specimen retained over several days |
| Comp. 1 | Specimen not water-resistant: |
| | Specimen disintegrates completely after just around 10 minutes' water |
| | storage |
| Comp.2 | Specimen not water-resistant: |
| | Specimen disintegrates immediately on water storage |
| Comp.3 | Specimen not water-resistant: |
| | Specimen disintegrates immediately on water storage |

The solid resins of the invention stably bind the fillers even after water storage—in contrast to the solid resins of Comparative examples 1 to 3.

### Testing of the Solid Resins in Tile Adhesives

Cementitious tile adhesives were produced from the following formula, in accordance with the figures in table 2:
250 g Milke CEM I,
100 g Fondu Lafarge,
282 g fine quartz sand,
332 g coarse quartz sand,
3.6 g Tylose,
1.0 g accelerator,
1.4 g retarder,
30 g VINNAPAS polymer powder (trade name of Wacker Chemie),
optionally 10 g of solid resin, as indicated in table 2,
200 g water.

Using the tile adhesive formulas, tile adhesives were produced conventionally and applied conventionally for producing tile assemblies. The shear strength of the tile assemblies was tested according to DIN 53265. The results of the testing are collated in table 2.

TABLE 2
Testing of the solid resins in tile adhesives:

| Solid resin | | Example 1 | Example 2 |
|---|---|---|---|
| Shear strength (N/mm²) after dry | 1.87 | 2.71 | 1.93 |
| storage ^{a)} | | | |
| Shear strength (N/mm²) after wet | 1.51 | 2.01 | 1.88 |
| storage ^{b)} | | | |

^{a)} 28 d SC: Testing after 28 days of storage under standard conditions;
^{b)} 7 d SC/21 d WS: Testing after 7 days of storage under standard conditions and 21 days of wet storage (at 23° C. in water).

The polymers of the invention improve the adhesive tensile strength of the tile assembly, particularly in the case of water storage.

1-13. (canceled)

14. A construction material dry mix containing one or more hydraulically setting binders, one or more fillers and optionally one or more additives, characterized in that it contains one or more water-soluble solid vinyl ester resins, obtainable by solution polymerization or bulk polymerization of
a) 60% to 99.4% by weight of one or more vinyl esters of carboxylic acids having 1 to 20 carbon atoms,
b) 0.1% to 20% by weight of one or more ethylenically unsaturated monomers containing silane groups, and
c) 0.5% to 20% by weight of one or more ionic, ethylenically unsaturated monomers, where the figures in % by weight are each based on the total weight of the solid vinyl ester resins.

15. The construction material dry mix as claimed in claim 14, wherein the water-soluble solid vinyl ester resins are based to an extent of 80% to 98.5% by weight of vinyl esters a), based on the total weight of the water-soluble solid vinyl ester resins.

16. The construction material dry mix as claimed in claim 14, wherein one or more silane monomers b) are unsaturated silicon compounds of the general formula R¹SiR²₀₋₂(OR³)₁₋₃,
where the definition of R¹ is CH₂═CR⁴—(CH₂)₀₋₁ or CH₂═CR⁴CO₂(CH₂)₁₋₃, the definition of R² is C₁ to C₃ alkyl radical, C₁ to C₃ alkoxy radical or halogen, R³ is an unbranched or branched, optionally substituted alkyl radical having 1 to 12 carbon atoms or an acyl radical having 2 to 12 carbon atoms, where R³ may optionally be interrupted by an ether group, and R⁴ is H or CH₃, and/or
one or more silane monomers b) are (meth) acrylamides containing silane groups, of the general formula CH₂═CR⁵—CO—NR⁶—R⁷—SiR⁸n—(R⁹)₃₋ₘ, where n=0 to 4, m=0 to 2, R⁵ is either H or a methyl group, R⁶ is H or an alkyl group having 1 to 5 carbon atoms; R⁷ is an alkylene group having 1 to 5 carbon atoms or is a divalent organic group in which the carbon chain is interrupted by an O or Natom, R⁸ is an alkyl group having 1 to 5 carbon atoms, and R⁹ is an alkoxy group having 1 to 40 carbon atoms which may be substituted by further heterocycles.

17. The construction material dry mix as claimed in claim 14, wherein one or more silane monomers b) are selected from the group encompassing vinyltrimethoxysilane, vinylmethyldimethoxysilane, vinyltriethoxysilane, vinylmethyldiethoxysilane, vinyltris(1-methoxy)isopropoxysilane, methacryloxypropyltris(2-methoxyethoxy)silane, 3-methacryl-oxypropyltrimethoxysilane, 3-methacryloxypropylmethyldimethoxysilane and methacryl-oxymethyltrimethoxysilane.

18. The construction material dry mix as claimed in claim 14, wherein ionic monomers c) are ethylenically unsaturated monomers which additionally carry a carboxylic acid, sulfonic acid, sulfate or phosphonic acid group.

19. The construction material dry mix as claimed in claim 14, wherein one or more ionic monomers c) are selected from the group encompassing acrylic acid, methacrylic acid, itaconic acid, fumaric acid, maleic acid, monoesters and diesters of fumaric acid and maleic acid, methallyl sulfonate, vinylsulfonic acid, 2-acrylamido-2-methyl-propanesulfonic acid, styrenesulfonic acid, sulfoalkyl (meth)acrylates, sulfoalkyl itaconates, vinylsulfonic acid,
diallyldiethylammonium chloride, (3-methacryloxy)propyltrimethylammonium chloride, (3-methacryloxy)ethyltrimethylammonium chloride, (3-methacrylamido)pro-pyltrimethylammonium chloride, trimethyl-3-(1-acrylamido-1,1-dimethylpropyl)ammonium chloride, trimethyl-3-(1-acrylamido-1,1-dimethylbutyl)ammonium chloride, dimethylacrylamidopropyl-4-trimethylammonium butenyl-2-ammonium chloride, 2-(acrylamidomethoxy)ethyltrimethylammonium chloride and diallyldimethylammonium chloride.

20. The construction material dry mix as claimed in claim 14, wherein the dry mix contains 0.1% to 50% by weight of water-soluble solid vinyl ester resins, based on the dry weight of the construction material dry mix.

21. A premix containing protective colloid-or emulsifier-stabilized polymers based on ethylenically unsaturated monomers in the form of water-redispersible powders, and water-soluble solid vinyl ester resins, wherein the water-soluble solid vinyl ester resins are obtainable by solution polymerization or bulk polymerization of
a) 60% to 99.4% by weight of one or more vinyl esters of carboxylic acids having 1 to 20 carbon atoms,
b) 0.1% to 20% by weight of one or more ethylenically unsaturated monomers containing silane groups, and
c) 0.5% to 20% by weight of one or more ionic, ethylenically unsaturated monomers, where the figures in % by weight are each based on the total weight of the solid vinyl ester resins.

22. A construction material dry mix as claimed in claim 14, wherein the dry mix contains 0.15% to 55% by weight, based on the dry weight of the construction material dry mix, of a premix containing protective colloid-or emulsifier-stabilized polymers based on ethylenically unsaturated monomers in the form of water-redispersible powders, and water-soluble solid vinyl ester resins, wherein the water-soluble solid vinyl ester resins are obtainable by solution polymerization or bulk polymerization of
a) 60% to 99.4% by weight of one or more vinyl esters of carboxylic acids having 1 to 20 carbon atoms,
b) 0.1% to 20% by weight of one or more ethylenically unsaturated monomers containing silane groups, and
c) 0.5% to 20% by weight of one or more ionic, ethylenically unsaturated monomers, where the figures in % by weight are each based on the total weight of the solid vinyl ester resins.

23. The use of the construction material dry mix of claim 14 as a reinforcing compound for thermal insulation composite systems, or as a bonding agent for thermal insulation boards, soundproofing boards, tile adhesives, or as a bonding agent for bonding wood or woodbase materials, or as a coating material such as a mortar, leveling compound, screed or render.
